(19) United States
(12) Patent Application Publication
(10) Pub. No.: US 2008/0043141 A1
(43) Pub. Date: Feb. 21, 2008

(54) Video signal scaling apparatus

(75) Inventor: Toshiyuki Namioka, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/808,475

(22) Filed: Jun. 11, 2007

(30) Foreign Application Priority Data
Jun. 30, 2006 (JP) 2006-181954

(51) Int. Cl. H04N 11/20

(52) U.S. Cl. 348/452; 348/E11.021

(57) ABSTRACT

According to one embodiment, a video signal scaling apparatus converts an input video signal and outputs as a scaling video signal while enlarging or reducing the number of pixels. The video signal scaling apparatus includes an adaptive interpolation circuit converting the input video signal and outputting as an interpolation video signal of which pixels are interpolated, and a scaling circuit converting the inputted video signal and enlarging or reducing the number of pixels with an arbitrary scale. Further, the video signal scaling apparatus includes a selection circuit selectively inputting either of the interpolation video signal outputted from the adaptive interpolation circuit or the input video signal to the scaling circuit based on a selection control signal inputted from external, and a scaling control circuit switching a parameter relating to the conversion at the scaling circuit based on the selection control signal.

### CROSS-REFERENCE TO RELATED APPLICATIONS

This application is based upon and claims the benefit of priority from Japanese Patent Application Publication (KOKAI) No. 2006-181954, filed Jun. 30, 2006, the entire contents of which are incorporated herein by reference.

### BACKGROUND

1. Field

One embodiment of the invention relates to a video signal scaling apparatus converting an input video signal, and outputting as a scaling video signal while enlarging or reducing the number of pixels thereof.

2. Description of the Related Art

A variety of formats such as an NTSC, PAL, high-definition television, personal computer signal, and so on exist in a video signal. When these video signals in various formats are to be displayed on displays having various numbers of pixels, a scaling process is required in which a signal format is converted in accordance with the number of pixels of respective displays. As conventional scaling apparatuses to perform such scaling process, for example, those described in Japanese Patent Application Publication (KOKAI) No. 2000-56311 (Patent Document 1), Japanese Patent Application Publication (KOKAI) No. 2004-254273 (Patent Document 2), Japanese Patent Application Publication (KOKAI) No. 2002-218281 (Patent Document 3), and Japanese Patent Application Publication (KOKAI) No. 2000-115720 (Patent Document 4) are known.

### BRIEF DESCRIPTION OF THE SEVERAL VIEWS OF THE DRAWINGS

A general architecture that implements the various features of the invention will now be described with reference to the drawing. The drawing and the associated descriptions are provided to illustrate embodiments of the invention and not to limit the scope of the invention.

FIG. 1 is an exemplary block diagram showing an embodiment of a video signal scaling apparatus according to an embodiment of the invention.

### DETAILED DESCRIPTION

Various embodiments according to the invention will be described hereinafter with reference to the accompanying drawing. In general, according to one embodiment of the invention, a video signal scaling apparatus converts an input video signal, enlarges or reduces the number of pixels, and outputs as a scaling video signal. The video signal scaling apparatus includes: an adaptive interpolation circuit converting the input video signal and outputting as an interpolation video signal of which pixels are interpolated; and a scaling circuit converting the inputted video signal, and enlarging or reducing the number of pixels with an arbitrary scale. Further, the video signal scaling apparatus includes: a selection circuit selectively inputting either of the interpolation video signal outputted from the adaptive interpolation circuit or the input video signal to the scaling circuit based on a selection control signal inputted from external; and a scaling control circuit switching a parameter relating to the conversion at the scaling circuit based on the selection control signal.

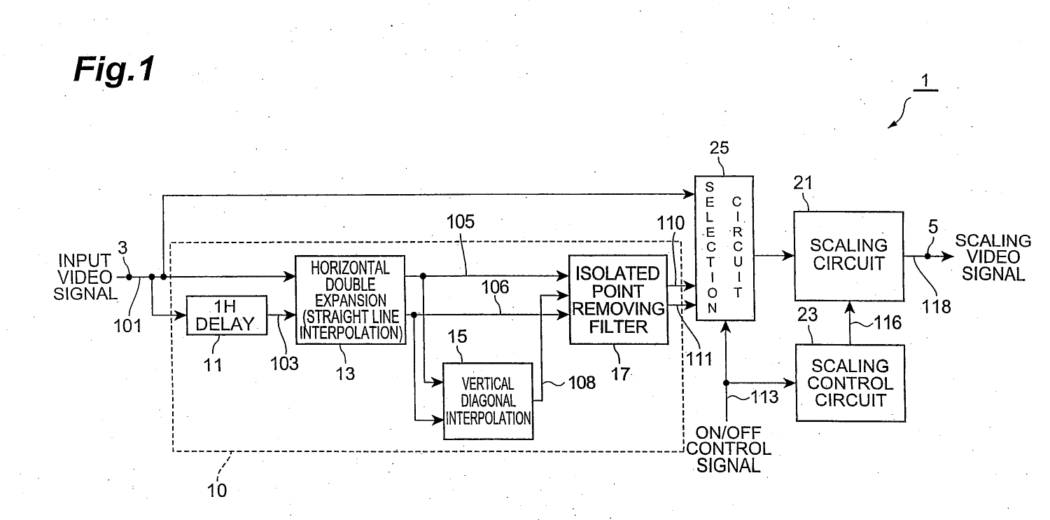

A video signal scaling apparatus 1 shown in FIG. 1 is an apparatus converting an input video signal 101 from an input 3, enlarging or reducing the number of pixels, and outputting as a scaling video signal 118 from an output 5. This apparatus 1 can be used as a television broadcast receiver for a full HD panel, and for example, it is possible to perform a scaling process of an SD signal with the number of pixels of 720×480 and output an HD signal with the number of pixels of 1920×1080.

This scaling apparatus 1 includes an adaptive interpolation circuit 10 performing a process interpolating the number of pixels of the input video signal 101, and a scaling circuit 21 enlarging or reducing the number of pixels of the inputted video signal with an arbitrary scale. Further, the scaling apparatus 1 includes a scaling control circuit 23 outputting a scaling control signal 116 to the above-stated scaling circuit 21, and a selection circuit 25 selecting a video signal to be inputted to the scaling circuit 21.

The above-stated adaptive interpolation circuit 10 includes a 1H delay circuit 11 delaying a video signal for 1H, a horizontal double expansion circuit (horizontal expansion circuit) 13 expanding to double the number of pixels in a horizontal direction of the input video signal 101, and a vertical diagonal interpolation circuit (vertical expansion circuit) 15 expanding to double the number of scanning lines of a video signal outputted from the horizontal double expansion circuit 13. Further, the adaptive interpolation circuit 10 includes an isolated point removing filter 17 removing an isolated point accidentally generated at the vertical diagonal interpolation circuit 15.

In this scaling apparatus 1, the input video signal 101 from the input 3 is inputted to the adaptive interpolation circuit 10, and guided to the 1H delay circuit 11 and horizontal double expansion circuit 13. Besides, the input video signal 101 is also inputted to the selection circuit 25 while bypassing the adaptive interpolation circuit 10. In the adaptive interpolation circuit 10, a delay video signal 103 delayed from the input video signal 101 for 1H is outputted from the 1H delay circuit 11 to which the input video signal 101 is inputted, and it is inputted to the horizontal double expansion circuit 13.

The horizontal double expansion circuit 13 inputs the input video signal 101 and delay video signal 103, doubles the number of pixels in the horizontal direction for the respective inputs by an interpolation filter, and outputs a horizontal expansion video signal 105 and a horizontal expansion video signal 106 delayed for 1H. Incidentally, as the above-stated interpolation filter, for example, a straight line interpolation between two points is used here.

The vertical diagonal interpolation circuit 15 inputs the horizontal expansion video signal 105 and horizontal expansion video signal 106 delayed for 1H. The vertical diagonal interpolation circuit 15 expands to double the number of scanning lines of a video signal by performing a process to generate an interpolation scanning line interpolating between a scanning line by the signal 105 and a scanning line by the signal 106 adjacent with each other, as an interpolation signal 108.

As the interpolation process used here, diagonal interpolation methods as stated below can be used. For example, when each interpolation pixel of the interpolation signal 108 to be interpolated is generated, correlations between pixel values with each other are detected as for paired pixels of the horizontal expansion video signals 105, 106 positioning in a relation sandwiching the corresponding interpolation pixel in each direction (including a diagonal direction). A direction of which detected correlation is the highest is selected, and an interpolation calculation is performed by using the paired pixels sandwiching the corresponding interpolation pixel in the selected direction, to generate the corresponding interpolation pixel. Besides, a publicly known method according to a diagonal interpolation may be used as the interpolation process used here.

The generated interpolation signal 108 is inputted to the isolated point removing filter 17 together with the horizontal expansion video signals 105, 106. As stated above, when the number of scanning lines of the video signal is expanded, the correlation in the diagonal direction of the video signal is detected by the vertical expansion circuit, the process is performed performing the interpolation in the direction having the high correlation, and therefore, the aliasing of the diagonal edge in the video signal after expansion is reduced.

In the above-stated diagonal interpolation process, there is a case when a pixel having no correlation with peripheral pixels (isolated point) may be accidentally generated when the interpolation direction was wrong at the diagonal interpolation circuit 15. Accordingly, the horizontal expansion video signals 105, 106 and interpolation signal 108 are inputted to the isolated point removing filter 17, then the isolated point generated as stated above is removed, and a first diagonal interpolation expansion signal (interpolation video signal) 110 and second diagonal interpolation expansion signal (interpolation video signal) 111 are generated. These first diagonal interpolation expansion signal 110 and second diagonal interpolation expansion signal 111 are outputted from the adaptive interpolation circuit 10, and inputted to the selection circuit 25. Hereinafter, the first diagonal interpolation expansion signal 110 and second diagonal interpolation expansion signal 111 are collectively referred to as “interpolation video signals”.

As stated above, the input video signal 101 and the interpolation video signals 110, 111 are inputted to the selection circuit 25, and an ON/OFF control signal (selection control signal) 113 from external (for example, from a control CPU of a television broadcast receiver) is inputted to the selection circuit 25. When the ON/OFF control signal 113 is ON, the selection circuit 25 outputs the interpolation video signals 110, 111 to the scaling circuit 21.

Besides, when the ON/OFF control signal 113 is OFF, the selection circuit 25 outputs the input video signal 101 to the scaling circuit 21. As stated above, either of the interpolation video signals 110, 111 or input video signal 101 are/is selectively inputted to the scaling circuit 21 by the selection circuit 25.

In other words, whether the process of the input video signal 101 by the adaptive interpolation circuit 10 is turned ON (process is performed) or OFF (process is not performed) at a preceding stage of the scaling circuit 21 is switched by the ON/OFF control signal 113 from external. For example, in case when an HD signal is required as the scaling video signal 118, it is preferable that the process by the adaptive interpolation circuit 10 is turned ON when the input video signal 101 is an SD signal, and the process by the adaptive interpolation circuit 10 is turned OFF when the input video signal 101 is the HD signal.

Next, the scaling circuit 21 determines a parameter in accordance with the scaling control signal 116 from the scaling control circuit 23, converts the number of pixels of the inputted video signal into the required number of pixels by enlarging or reducing it with a predetermined scale, and outputs as the scaling video signal 118. In this case, the video signal inputted to the scaling circuit 21 is either of the interpolation video signals 110, 111, or input video signal 101 as stated above. Among them, the interpolation video signals 110, 111 pass through the adaptive interpolation circuit 10, and therefore, they have double the numbers of pixels in both horizontal direction and vertical direction, compared to the input video signal 101.

Here, the above-stated ON/OFF control signal 113 is also inputted to the scaling control circuit 23, and the scaling control circuit 23 generates the scaling control signal 116 so as to switch the above-stated parameter in the scaling circuit 21 based on this ON/OFF control signal 113. This switching of parameter is performed so that the number of pixels of the scaling video signal 118 becomes to be the same regardless of the ON/OFF state of the ON/OFF control signal 113.

Namely, concretely speaking, the above-stated parameter contains information of the scale of enlargement or reduction of the number of pixels (hereinafter, referred to as an “enlargement/reduction scale”) performed at the scaling circuit 25. The scaling control circuit 23 switches the above-stated parameter in the scaling circuit 21 so that the enlargement/reduction scale becomes half when the ON/OFF control signal 113 is in the ON state, compared to the case when the ON/OFF control signal 113 is in the OFF state.

Incidentally, a signal showing the number of pixels of the input video signal 101 and the number of pixels of the scaling video signal 118 is inputted to the scaling control circuit 23, and the above-stated enlargement/reduction scale is determined based on the number of pixels of the input video signal 101 and the number of pixels of the scaling video signal 118 contained in the control signal of the scaling control circuit 23.

Consequently, the parameter in the scaling circuit 21 is switched in conjunction with the ON/OFF of the process by the adaptive interpolation circuit 10, and thereby, an adequate enlargement/reduction scale is automatically applied. Accordingly, it becomes possible to make the number of pixels of the scaling video signal 118 outputted from the scaling circuit 21 to be the same automatically regardless of the ON/OFF of the process of the input video signal 101 by the adaptive interpolation circuit 10.

As stated above, according to this video signal scaling apparatus 1, the aliasing of the diagonal edge of the scaling video signal is improved because the expansion of the input video signal in the vertical direction is performed by using the above-stated diagonal interpolation process in the process by the adaptive interpolation circuit 10 preceding to the process by the scaling circuit 21.

Besides, in this apparatus 1, it is possible to turn ON/OFF the process by the above-stated adaptive interpolation circuit 10, but the parameter of the scaling process is automatically selected so that the number of pixels of the final scaling video signal 118 becomes the same regardless of the ON/OFF of this process. As a result, it is possible to perform a similar control of this apparatus 1 from external (for example, from a control CPU of the television broadcast receiver) in both cases when the process by the above-stated adaptive interpolation circuit 10 is ON and OFF.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal scaling apparatus which converts an input video signal, enlarges or reduces the number of pixels, and outputs as a scaling video signal, said video signal scaling apparatus comprising:
an adaptive interpolation circuit converting the input video signal and outputting as an interpolation video signal of which pixels are interpolated;
a scaling circuit converting the inputted video signal, and enlarging or reducing the number of pixels with an arbitrary scale;
a selection circuit selectively inputting either of the interpolation video signal outputted from said adaptive interpolation circuit or the input video signal to said scaling circuit based on a selection control signal inputted from external; and
a scaling control circuit switching a parameter relating to the conversion at said scaling circuit based on the selection control signal.

2. The video signal scaling apparatus according to claim 1,
wherein said adaptive interpolation circuit includes:
a horizontal expansion circuit expanding to double the number of pixels of the input video signal in a horizontal direction; and
a vertical expansion circuit expanding to double the number of scanning lines of a horizontal expansion video signal outputted from the horizontal expansion circuit, and
wherein the vertical expansion circuit detects a correlation of a video in the horizontal expansion video signal outputted from the horizontal expansion circuit in a diagonal direction, and performs an interpolation based on a direction in which the detected correlation is high.

3. The video signal scaling apparatus according to claim 1,
wherein the parameter contains information of a scale of enlargement or reduction of the number of pixels relating to the conversion at said scaling circuit.
